(19) United States
(12) Patent Application Publication
(10) Pub. No.: US 2022/0292936 A1
(43) Pub. Date: Sep. 15, 2022

(54) COMMODITY SALES DATA PROCESSING DEVICE AND METHOD

(71) Applicant: TOSHIBA TEC KABUSHIKI KAISHA, Tokyo (JP)

(72) Inventors: Takahiro Saitou, Izunokuni Shizuoka (JP); Atsushi Miyashima, Izunokuni Shizuoka (JP); Toshihiro Kaneko, Izunokuni Shizuoka (JP); Yuki Kawaguchi, Tagata Shizuoka (JP); Taiki tanihira, Izunokuni Shizuoka (JP); Shinsuke Yajima, Mishima Shizuoka (JP); Hidehiro Naito, Mishima Shizuoka (JP); Masaki Ito, Numazu Shizuoka (JP)

(21) Appl. No.: 17/541,303

(22) Filed: Dec. 3, 2021

(30) Foreign Application Priority Data
Mar. 11, 2021 (JP) 2021-039602

(51) Int. Cl. G07G 3/00; G06Q 20/20; G07G 1/00; G06Q 20/18; G01G 19/414; G01P 13/00; G06T 7/70

(52) U.S. Cl. CPC G07G 3/003; G06Q 20/208; G07G 1/0072; G06Q 20/18; G06Q 20/204; G01G 19/4144; G01P 13/00; G06T 7/70; G06T 2207/30232

(57) ABSTRACT

According to one embodiment, a commodity sales data processing device includes a commodity registration unit, a payment processing unit, a detection control unit, a measurement control unit, and a fraud detection unit. The commodity registration unit registers commodities. The payment processing unit settles the price for registered commodities. The detection control unit detects the presence or absence of an operator. The measurement control unit measures the weight applied to the bag packing stand on which the registered commodities are placed. The fraud detection unit detects the movement of an unsettled commodity to the bag packing stand according to detection of a weight change of the weight applied to the bag packing stand after settlement is completed and if the operator is detected.

### CROSS-REFERENCE TO RELATED APPLICATION

This application is based upon and claims the benefit of priority from Japanese Patent Application No. 2021-039602, filed on Mar. 11, 2021, the entire contents of which are incorporated herein by reference.

### FIELD

Embodiments described herein relate generally to a commodity sales data processing device and a method.

### BACKGROUND

In the related art, known are a self-service type POS terminal (Point Of Sales) in which a shopper acts as an operator to register commodities and perform settlement, and a semi-self-service type POS terminal in which a shopper acts as an operator to perform settlement after a store clerk registers commodities.

In such a POS terminal, a malicious customer or the like may perform fraudulent acts such as adding an unregistered commodity after the completion of payment processing pretending to have forgotten to pack the commodity.

### DESCRIPTION OF THE DRAWINGS

FIG. 1 is a perspective view showing an example of an appearance seen from the operator side of a self-service POS terminal according to an embodiment;

FIG. 2 is a diagram showing an example of a hardware configuration of the self-service POS terminal;

FIG. 3 is a diagram showing an example of a functional configuration of the self-service POS terminal; and

FIG. 4 is a flowchart showing an example of commodity sales data processing executed in the self-service POS terminal.

### DETAILED DESCRIPTION

Embodiments provide a commodity sales data processing device and a method that can detect fraudulent acts of packing unregistered commodities.

In general, according to one embodiment, the commodity sales data processing device includes a commodity registration unit, a payment processing unit, a detection control unit, a measurement control unit, and a fraud detection unit. The commodity registration unit registers commodities. The payment processing unit settles the price for the registered commodities. The detection control unit detects the presence or absence of an operator. The measurement control unit measures the weight applied to the bag packing stand on which the registered commodities are placed. The fraud detection unit detects movement of an unsettled commodity to the bag packing stand according to the detection of a weight change of the weight applied to the bag packing stand after the settlement is completed and if the operator is detected.

Hereinafter, the commodity sales data processing device and the method according to the embodiment will be described with reference to the drawings. The present embodiment exemplifies a self-service type POS (Point Of Sales) terminal as a commodity sales data processing device, in which a shopper acts as an operator to register commodities and perform settlement. The self-service POS terminal according to the embodiment is an example of a sales data processing device that executes the commodity registration processing that registers a commodity to be sold and the payment processing of the commodity registered by the commodity registration processing by a customer operation.

The technique according to the embodiment can also be applied to a semi-self-service type POS terminal in which a shopper acts as an operator to perform settlement after a store clerk registers commodities.

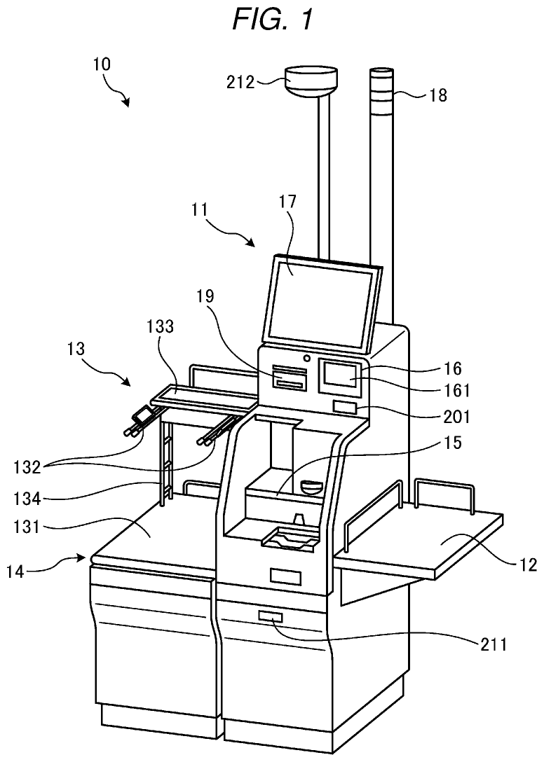

FIG. 1 is a perspective view showing an example of the appearance of a self-service POS terminal 10 according to the embodiment as seen from the operator side. As shown in FIG. 1, the self-service POS terminal 10 includes a main body 11, a basket stand 12, and a bag packing stand 13.

The main body 11 is provided between the basket stand 12 and the bag packing stand 13. The basket stand 12 is a storage stand on which the basket is placed at the time of commodity registration. The bag packing stand 13 is a storage stand on which the shopping bag is hung in an open state. Commodities for which commodity registration was completed are placed in a shopping bag. In other words, the registered commodity is placed on the bag packing stand 13.

The bag packing stand 13 includes a pedestal 131, a bag hook 132, and a temporary stand 133. The bag hook 132 and the temporary stand 133 are supported on a support column 134 provided on the pedestal 131 and are provided above the pedestal 131. The pedestal 131 is a stand on which a commodity or the like that is not suitable for being put in a bag, such as a commodity larger than the bag, is placed. The bag hook 132 is a hook for hanging a bag that holds the commodities registered for sale. The temporary stand 133 is a stand on which, for example, fragile commodities and other commodities that require attention in bag packing are temporarily placed.

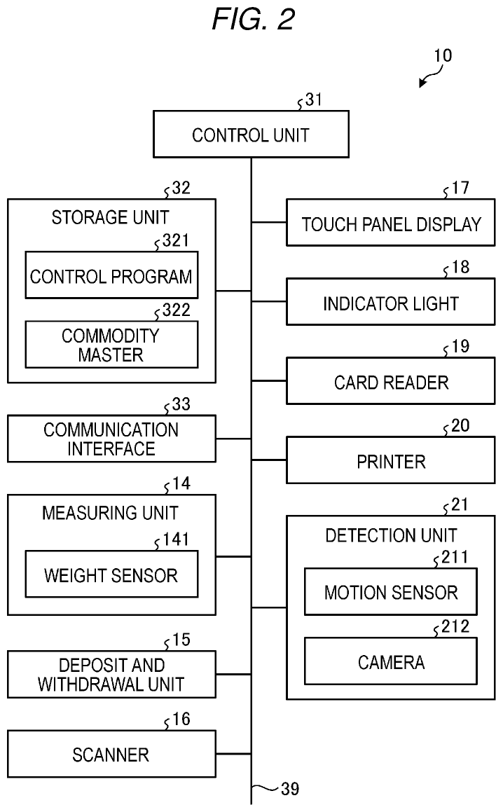

FIG. 2 is a diagram showing an example of the hardware configuration of the self-service POS terminal 10 according to the embodiment. As shown in FIG. 2, the self-service POS terminal 10 includes a measuring unit 14, a deposit and withdrawal unit 15, a scanner 16, a touch panel display 17, an indicator light 18, a card reader 19, a printer 20, a detection unit 21, a control unit 31, a storage unit 32, and a communication interface 33. The measuring unit 14, the deposit and withdrawal unit 15, the scanner 16, the touch panel display 17, the indicator light 18, the card reader 19, the printer 20, the detection unit 21, the control unit 31, the storage unit 32, and the communication interface 33 are connected to each other via system buses 39 such as data buses, address buses and the like.

As shown in FIG. 1, the measuring unit 14 is provided on the bag packing stand 13. The measuring unit 14 is a device that measures the weight of an article such as a commodity placed on the bag packing stand 13 based on the output of a weight sensor 141. For example, the measuring unit 14 measures the total weight of the bag set on the bag packing stand 13 and the commodities put in the bag. As an example, the measuring unit 14 has a weight sensor 141 as shown in FIG. 2. The weight sensor 141 is provided below, for example, the pedestal 131 and supports the pedestal 131. The weight sensor 141 is configured to output a signal according to the force applied from the pedestal 131.

As shown in FIG. 1, the deposit and withdrawal unit 15 is provided, for example, in the central portion of the main body 11. The deposit and withdrawal unit 15 includes, for example, a coin insertion unit, a coin discharge unit, a banknote insertion unit, and a banknote discharge unit. The coin insertion unit is an insertion slot that accepts the insertion of coins paid by a customer. The coin discharge unit is a tray for receiving coins discharged from the deposit and withdrawal unit 15 for change and the like. The banknote insertion unit is an insertion slot that accepts the insertion of banknotes paid by a customer. The banknote discharge unit is a discharge port for banknotes discharged from the deposit and withdrawal unit 15 for change and the like. The deposit and withdrawal unit 15 may not be provided, for example, if the self-service POS terminal 10 is configured as a cashless terminal that does not handle cash.

As shown in FIG. 1, the scanner 16 is provided above the deposit and withdrawal unit 15 in the main body 11, for example. The scanner 16 has a reading window 161 as shown in FIG. 1.

The scanner 16 is, for example, a reading device that reads commodity information from code symbols such as wireless tags and barcodes attached to commodities held over the reading window 161. The wireless tag is an electronic tag such as a Radio Frequency (RF) tag. The wireless tag has an Integrated Circuit (IC) chip for storing information, and an antenna. The wireless tag transmits the tag information stored in the IC chip according to the radio wave received from the wireless tag reader. For example, the wireless tag stores commodity information about a commodity to which the wireless tag is attached. The commodity information includes, for example, a commodity code that can identify the commodity.

The scanner 16 may have, for example, a camera configured to capture an image of a commodity held over the reading window 161. The camera of the scanner 16 includes an imaging sensor such as a Complementary Metal-Oxide Semiconductor (CMOS) or a Charge Coupled Device (CCD). The reading window 161 can transmit the light captured by the camera of the scanner 16. The image data of the commodity captured by the camera of the scanner 16 is subjected to object recognition processing by the image processing device. As a result, the commodity included in the image data is specified and registered. The image processing device is an external device that is communicably connected to the self-service POS terminal 10 via, for example, the communication interface 33. The object recognition processing may be executed by the self-service POS terminal 10.

As shown in FIG. 1, the touch panel display 17 is provided above the scanner 16 in the main body 11, for example. The touch panel display 17 displays various screens and accepts operations by customers.

As shown in FIG. 1, the indicator light 18 is provided behind the touch panel display 17 in the main body 11, for example. The indicator light 18 is an electric light that notifies the store clerk that an abnormality occurred in the self-service POS terminal 10.

As shown in FIG. 1, the card reader 19 is provided on the side of the scanner 16 in the main body 11, for example. The card reader 19 is a reading device that reads a card such as a credit card.

The printer 20 is provided inside, for example, the housing of the main body 11. The printer 20 is a printing device that prints a receipt showing the details of one transaction and a coupon such as a discount on a commodity on receipt paper or the like. The printer 20 has a receipt discharge unit 201. As shown in FIG. 1, a receipt discharge unit 201 is provided between the deposit and withdrawal unit 15 and the scanner 16 in the main body 11, for example. The receipt discharge unit 201 is a discharge port that discharges the receipt or the like dispensed by the printer 20 to the outside of the self-service POS terminal 10.

As shown in FIGS. 1 and 2, the detection unit 21 includes a motion sensor 211 and a camera 212.

The motion sensor 211 is a sensor that detects the presence or absence of an operator of the self-service POS terminal 10. The motion sensor 211 is provided, for example, below the deposit and withdrawal unit 15 of the main body 11. Here, the presence or absence of an operator of the self-service POS terminal 10 is, for example, the presence or absence of a person located on the operation side of the self-service POS terminal 10. The operation side of the self-service POS terminal 10 is, for example, the display surface side of the touch panel display 17. As an example, the motion sensor 211 is configured to detect the presence or absence of a person at a position where an article can be added to the bag packing stand 13. As the motion sensor 211, for example, an infrared sensor can be used.

The camera 212 is a camera configured to image the operator of the self-service POS terminal 10. The camera 212 includes an imaging sensor such as CMOS or CCD. The image data of the operator captured by the camera 212 is subjected to object recognition processing by the image processing device. The object recognition processing can be used to identify the position of the article before the movement with respect to the movement of the article to the bag packing stand 13 by the operator. The image processing device is an external device that is communicably connected to the self-service POS terminal 10 via, for example, the communication interface 33. The object recognition processing may be executed by the self-service POS terminal 10.

The detection unit 21 may further have a distance sensor as a configuration for detecting the movement of the article by the operator of the self-service POS terminal 10. For example, the output of the distance sensor can be used to detect the movement of an article held by the operator or the movement of the operator. Alternatively, the camera 212 may be configured as an RGB-D camera.

The control unit 31 is a computer that controls the overall operation of the self-service POS terminal 10 and implements various functions of the self-service POS terminal 10. The control unit 31 includes a Central Processing Unit (CPU), a Read Only Memory (ROM), and a Random Access Memory (RAM). The CPU is a processor that comprehensively controls the operation of the self-service POS terminal 10. For example, the ROM is a storage medium for storing various programs and data. The RAM is a storage medium that temporarily stores various programs and various data. The CPU executes various programs stored in the ROM, the storage unit 32, or the like using the RAM as a work area.

The processor of the control unit 31 is not limited to the CPU, and other processors such as Graphics Processing Unit (GPU), Application Specific Integrated Circuit (ASIC), and Field Programmable Gate Array (FPGA) may be used.

The storage unit 32 is a storage device such as a Hard Disk Drive (HDD), a Solid State Drive (SSD), or a flash memory. The storage unit 32 stores a control program 321 and a commodity master 322.

The control program 321 is a program for exerting various functions of the operating system and the self-service POS terminal 10. The control program 321 includes a program for implementing various functions according to the present embodiment in the control unit 31 according to the present embodiment.

The commodity master 322 is information in which commodity information related to the commodity is stored for each commodity. Information such as a commodity code, a name, an amount of money, and a collation weight value is associated with the commodity master 322 as commodity information. The commodity code is identification information that can identify the commodity. The name is the name of the commodity. The amount of money is the selling price of the commodity. The collation weight value is collation information indicating the weight value of the commodity. Further, in the commodity master 322, a threshold value used for weight collation may be set for each commodity. The threshold value may be set uniformly regardless of the commodity or maybe set separately from the commodity master 322.

If the object recognition processing is executed on the self-service POS terminal 10, the commodity master 322 may be associated with the information of the collation feature data as the commodity information. The collation feature data is collation information indicating the features of the appearance of the commodity. The collation feature data is a parameterized appearance feature such as a standard shape of a commodity, a surface color, a pattern, and an uneven state.

The communication interface 33 is an interface for communicating with an external device of the self-service POS terminal 10 via a network. As the external device, for example, there may be an image processing device that executes image processing such as object recognition processing and human recognition processing. As the external device, for example, there may be an information processing device (hereinafter referred to as a management device) operated by a manager such as a store clerk who manages the self-service POS terminal 10. The management device is, for example, a personal computer, a tablet terminal, a smartphone, or the like. The management device is connected to, for example, a plurality of self-service POS terminals 10. Any self-service POS terminal 10 among the plurality of self-service POS terminals 10 connected to each other via the network may be used as the management device. The management device notifies the store clerk of fraud detection based on the notification information from the self-service POS terminal 10.

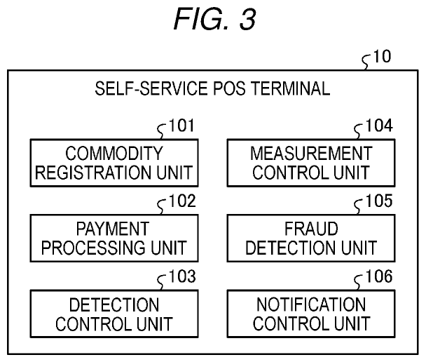

FIG. 3 is a diagram showing an example of the functional configuration of the self-service POS terminal 10 according to the embodiment. Some or all of the functions implemented by the self-service POS terminal 10 may be implemented in cooperation with an external device of the self-service POS terminal 10 or maybe implemented by a hardware configuration such as a dedicated circuit mounted on the self-service POS terminal 10.

The control unit 31 of the self-service POS terminal 10 executes the control program 321 loaded in the RAM to implement the functions as a commodity registration unit 101, a payment processing unit 102, a detection control unit 103, a measurement control unit 104, a fraud detection unit 105, and a notification control unit 106.

The commodity registration unit 101 registers the commodity to be sold based on the commodity code read from the code symbol such as the wireless tag or barcode attached to the commodity. The commodity registration unit 101 may register the commodity to be sold by identifying the commodity by object recognition based on the image data captured by the camera of the scanner 16. The commodity registration unit 101 is not limited to reading the commodity information and may register the commodity specified by the operation input.

The payment processing unit 102 controls the payment processing in which the price related to the commodity registered by the commodity registration unit 101 is settled. For example, the payment processing unit 102 calculates the total price of the commodities registered for sale by the commodity registration unit 101. Further, the payment processing unit 102 subtracts the total price from the amount of money input to the deposit and withdrawal unit 15 to calculate the change. In addition, the payment processing unit 102 causes the deposit and withdrawal unit 15 to discharge the change.

The detection control unit 103 detects the presence or absence of an operator of the self-service POS terminal 10 by controlling, for example, the motion sensor 211. The detection control unit 103 may detect the presence or absence of an operator of the self-service POS terminal 10 based on, for example, the result of human recognition processing based on the image data captured by the camera 212. Further, the detection control unit 103 is not limited to the camera 212 but may detect the presence or absence of an operator of the self-service POS terminal 10 based on image data obtained by a camera of the scanner 16 or a surveillance camera in the store where the self-service POS terminal 10 is installed.

The measurement control unit 104 measures the weight applied to the bag packing stand 13 by controlling the measuring unit 14.

After the completion of settlement and if the operator of the self-service POS terminal 10 is detected, the fraud detection unit 105 detects the movement of the unsettled commodity into the bag packing stand 13 according to the detection of a weight change of the weight applied to the bag packing stand 13. As an example, the fraud detection unit 105 detects the movement of an unsettled commodity to the bag packing stand 13 in response to the detection of a weight change in which the weight applied to the bag packing stand 13 increases.

Further, if the fraud detection unit 105 detects a weight change in which the weight applied to the bag packing stand 13 increases, the fraud detection unit 105 determines whether or not the article is an unsettled commodity based on the position of the article moved to the bag packing stand 13 before the movement. Specifically, the fraud detection unit 105 specifies the position before the movement of the article added to the bag packing stand 13 based on the result of object recognition processing on the time-series image data of the operator captured by the camera 212 if a weight change in which the weight applied to the bag packing stand 13 increases is detected. The fraud detection unit 105 determines that the article moved to the bag packing stand 13 is an unsettled commodity if the specified pre-movement position is a predetermined position. The predetermined position is a position where an unregistered commodity is easily placed, such as the basket stand 12 or the temporary stand 133, and may be freely set. It is assumed that the predetermined position is stored in the storage unit 32, for example.

The fraud detection unit 105 may specify the position of the article added to the bag packing stand 13 before the movement, based on the image data obtained not only by the camera 212 but also by the camera of the scanner 16 or the surveillance camera in the store where the self-service POS terminal 10 is installed.

For example, if the camera 212 is configured as an RGB-D camera or the detection unit 21 is further provided with a distance sensor, the fraud detection unit 105 specifies the position of the article added to the bag packing stand 13 before the movement, by motion capture of the operator. The position of the article added to the bag packing stand 13 before the movement may be specified by detecting a change in the position or posture of the article held by the operator.

Further, the fraud detection unit 105 detects the movement of unsettled commodities to the bag packing stand 13 based on the weight change of the weight applied to the bag packing stand 13 and the commodity information of the registered commodity until the settlement is completed. Specifically, the fraud detection unit 105 detects weight change based on whether or not the comparison result between the measuring result of the commodity added to the bag packing stand 13 by the measuring unit 14 and the collation weight value read from the commodity master 322 regarding the commodity registered by the commodity registration unit 101 is within a predetermined threshold range.

If the movement of an unsettled commodity to the bag packing stand 13 is detected after the settlement is completed, the notification control unit 106 alerts (notifies) the fraud detection. For example, the notification control unit 106 notifies the fraud detection by displaying on the touch panel display 17 a screen indicating the detection of fraud in which the unsettled commodity is moved to the bag packing stand 13 after the settlement is completed. For example, the notification control unit 106 notifies the fraud detection by turning on the indicator light 18, changing the emission color of the indicator light 18, or blinking the indicator light 18. For example, the notification control unit 106 notifies the fraud detection by outputting the notification information indicating the detection of fraud in which the unsettled commodity is moved to the bag packing stand 13 after the settlement is completed to the management device of the self-service POS terminal 10. The fraud detection notification may be implemented by a combination of the above-mentioned various notification methods.

Further, the notification control unit 106 notifies the fraud detection if the difference between the weight change of the bag packing stand 13 and the collation weight value is out of the predetermined threshold value until the settlement is completed. As described above, this fraud detection notification is also implemented, for example, by displaying on the touch panel display 17, turning on the indicator light 18, outputting to the management device, or the like.

The notification control unit 106 may include the image data obtained by the camera 212, the camera of the scanner 16, the surveillance camera in the store where the self-service POS terminal 10 is installed, and the like in the notification information output to the management device when notifying the fraud detection.

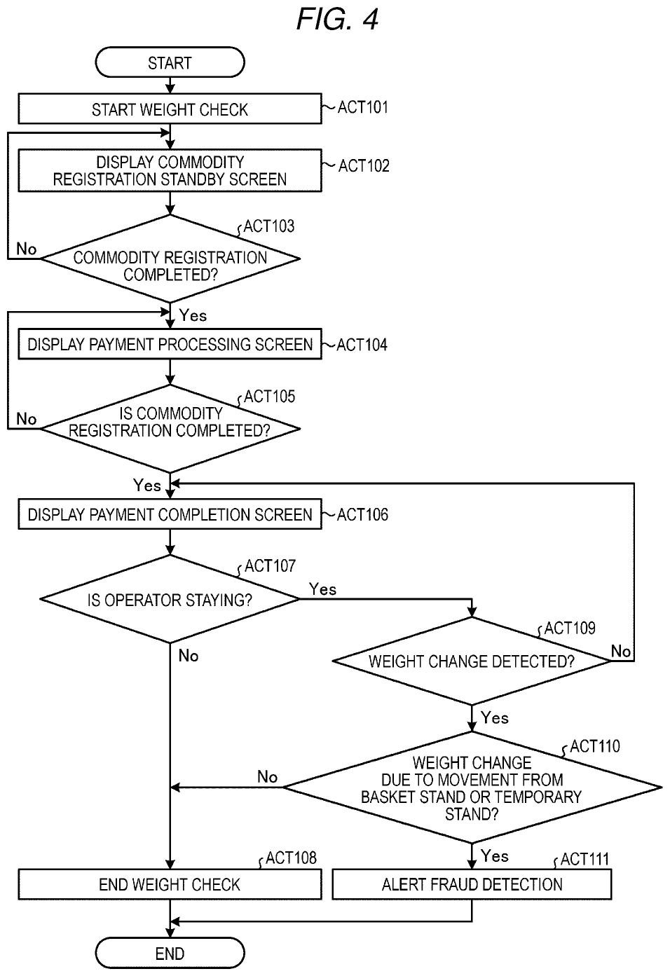

Hereinafter, the flow of processing executed by the self-service POS terminal 10 according to the embodiment will be described with reference to the drawings. FIG. 4 is a flowchart showing an example of commodity sales data processing executed in the self-service POS terminal 10 according to the embodiment. It is assumed that the flow of FIG. 4 is started if, for example, the motion sensor 211 detects the operator of the self-service POS terminal 10.

The fraud detection unit 105 starts the weight check (ACT 101). The commodity registration unit 101 starts the commodity registration processing after the weight check is started, and displays the commodity registration standby screen on the touch panel display 17 (ACT 102).

The fraud detection unit 105 determines whether or not the commodity registration was completed (ACT 103). The fraud detection unit 105 determines that the commodity registration was completed, for example, if the icon instructing the start of payment processing is selected on the commodity registration standby screen. If it is not determined that the commodity registration was completed (ACT 103: No), the flow of FIG. 4 returns to the process of ACT 102.

On the other hand, if it is determined that the commodity registration was completed (ACT 103: Yes), the payment processing unit 102 starts the payment processing of the commodities registered by the commodity registration processing and displays the payment processing screen on the touch panel display 17 (ACT 104).

The fraud detection unit 105 determines whether or not the payment processing was completed (ACT 105). The fraud detection unit 105 determines that the payment processing was completed, for example, if the payment related to the transaction is completed. If it is not determined that the payment processing was completed (ACT 105: No), the flow of FIG. 4 returns to the process of ACT 104.

On the other hand, if it is determined that the payment processing was completed (ACT 105: Yes), the payment processing unit 102 displays a payment completion screen on the touch panel display 17 for notifying the operator that the payment related to the transaction was completed (ACT 106).

After the commodity registration and payment related to one transaction were completed, the fraud detection unit 105 determines whether or not the operator of the self-service POS terminal 10 is staying, for example, based on the detection result of the motion sensor 211 (ACT 107).

If it is not determined that the operator of the self-service POS terminal 10 is staying (ACT 107: No), the fraud detection unit 105 ends the weight check (ACT 108). After that, the flow of FIG. 4 ends.

On the other hand, if it is determined that the operator of the self-service POS terminal 10 is staying (ACT 107: Yes), the fraud detection unit 105 determines whether or not the weight change is detected based on the measurement result by the measuring unit 14 (ACT 109).

If it is not determined that the weight change is detected (ACT 109: No), the flow of FIG. 4 returns to the process of ACT 106.

On the other hand, if it is determined that the weight change is detected (ACT 109: Yes), the fraud detection unit 105 determines whether or not the weight change is due to the movement of the article from the basket stand 12 or the temporary stand 133 based on the detection result by the camera 212 (ACT 110).

If it is not determined that the weight change is due to the movement of the article from the basket stand 12 or the temporary stand 133 (ACT 110: No), the flow of FIG. 4 proceeds to the process of ACT 108. This is a case where, for example, a wallet, a smartphone, or the like held by the operator's hand is put into a shopping bag installed on the bag hook 132. In other words, it is assumed that there is a low possibility that an unregistered commodity is fraudulently put in a shopping bag after the payment processing is completed, for example, pretending to have forgotten to pack the commodity.

On the other hand, if it is determined that the weight change is due to the movement of the article from the basket stand 12 or the temporary stand 133 (ACT 110: Yes), the notification control unit 106 alerts the fraud detection (ACT 111). This is a case where there is a high probability that an unregistered commodity placed on the basket stand 12 or the temporary stand 133 without registration is fraudulently put in a shopping bag, pretending to have forgotten to pack the commodity. After that, the flow of FIG. 4 ends.

The fraud detection may be notified if it is determined that the weight change is detected in the process of ACT 109. For example, if the weight change is detected after the settlement is completed, the notification control unit 106 may notify the possibility of fraud detection by outputting the notification information to the management device of the self-service POS terminal 10. As a result, it is possible to notify the manager such as a store clerk that there is a risk of fraud and call the manager's attention.

As described above, according to the commodity sales data processing device of the embodiment described by exemplifying the self-service POS terminal 10, the weight check of the bag packing stand 13 can be continued as long as the customer is in front of the self-service POS terminal 10 even after the payment processing is completed. As a result, it is possible to detect a fraud operation of adding an unregistered commodity even after the settlement is completed. In other words, the commodity sales data processing device of the embodiment can detect fraud such as packing an unregistered commodity in the bag by monitoring the weight change of the bag packing stand 13 even after the payment processing is completed.

In addition, the commodity sales data processing device of the embodiment can detect whether or not the article is an unregistered commodity based on the position before the movement of the article that caused the weight change after the payment processing is completed. As a result, if the movement is not from the basket stand 12 or the temporary stand 133, it is considered that the customer puts personal belongings such as a wallet, a bag, and a smartphone into a shopping bag packed with registered commodities and can be prevented from being detected as fraudulent.

As described above, according to the embodiment, it is possible to detect fraudulent acts of packing unregistered commodities in the bag.

Each control program executed by the self-service POS terminal 10 of the present embodiment is provided by being incorporated in a ROM or the like in advance.

Each control program executed by the self-service POS terminal 10 of the present embodiment may be configured to be recorded and provided on a computer-readable recording medium such as a CD-ROM, a flexible disk (FD), a CD-R, a Digital Versatile Disk (DVD), or the like, as a file in an installable format or an executable format.

Further, each control program executed by the self-service POS terminal 10 of the present embodiment may be stored on a computer connected to a network such as the Internet and provided by allowing the program to be downloaded via the network. Further, each control program executed by the self-service POS terminal 10 of the present embodiment may be provided or distributed via a network such as the Internet.

The control program 321 executed by the self-service POS terminal 10 of the present embodiment has a module configuration including the above-mentioned units (commodity registration unit 101, payment processing unit 102, detection control unit 103, measurement control unit 104, fraud detection unit 105, and notification control unit 106). The CPU (processor) reads the control program 321 from the storage medium and loads the respective units onto the main storage device. As a result, the commodity registration unit 101, the payment processing unit 102, the detection control unit 103, the measurement control unit 104, the fraud detection unit 105, and the notification control unit 106 are generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity sales data processing device, comprising:
a commodity registration component configured to register commodities;
a payment processing component configured to settle a price for registered commodities;
a detection controller configured to detect a presence or absence of an operator;
a measurement controller configured to measure a weight applied to a bag packing stand on which the registered commodities are placed; and
a fraud detection component configured to detect a movement of an unsettled commodity to the bag packing stand according to detection of a weight change of the weight applied to the bag packing stand after settlement is completed and if the operator is detected.

2. The commodity sales data processing device according to claim 1, wherein
if the fraud detection component detects a weight change in which the weight applied to the bag packing stand increases, the fraud detection component determines whether or not the article is the unsettled commodity based on a position before the movement of the article moved to the bag packing stand.

3. The commodity sales data processing device according to claim 2, wherein
the fraud detection component identifies the position before the movement of the article based on captured image data of the operator.

4. The commodity sales data processing device according to claim 1, further comprising:
a notification controller configured to notify fraud detection if the movement of the unsettled commodity to the bag packing stand is detected.

5. The commodity sales data processing device according to claim 1, wherein
until the settlement is completed, the fraud detection component detects the movement of the unsettled commodity to the bag packing stand based on the weight change of the weight applied to the bag packing stand and commodity information of the registered commodity.

6. The commodity sales data processing device according to claim 1, further comprising:
a scanner configured to read commodity information from code symbols.

7. The commodity sales data processing device according to claim 1, wherein
the detection controller comprises a motion sensor.

8. A method that causes a computer to:
register commodities;
settle a price for registered commodities;
detect a presence or absence of an operator;
measure weight applied to a bag packing stand on which the registered commodities are placed; and
detect a movement of an unsettled commodity to the bag packing stand according to detection of a weight change of the weight applied to the bag packing stand after settlement is completed and if the operator is detected.

9. The method according to claim 8, further comprising:
if a weight change is detected in which the weight applied to the bag packing stand increases, determining whether or not the article is the unsettled commodity based on a position before the movement of the article moved to the bag packing stand.

10. The method according to claim 9, further comprising:
identifying the position before the movement of the article based on captured image data of the operator.

11. The method according to claim 8, further comprising:
notifying fraud detection if the movement of the unsettled commodity to the bag packing stand is detected.

12. The method according to claim 8, further comprising:
until the settlement is completed, detecting the movement of the unsettled commodity to the bag packing stand based on the weight change of the weight applied to the bag packing stand and commodity information of the registered commodity.

13. The method according to claim 8, further comprising:
reading commodity information from code symbols.

14. A self-service Point Of Sales (POS) terminal, comprising:
a commodity registration component configured to register commodities;
a payment processing component configured to settle a price for registered commodities, the payment processing component comprising a card reader that reads a credit card;
a detection controller configured to detect a presence or absence of an operator;
a measurement controller configured to measure a weight applied to a bag packing stand on which the registered commodities are placed; and
a fraud detection component configured to detect a movement of an unsettled commodity to the bag packing stand according to detection of a weight change of the weight applied to the bag packing stand after settlement is completed and if the operator is detected.

15. The self-service POS terminal according to claim 14, wherein
if the fraud detection component detects a weight change in which the weight applied to the bag packing stand increases, the fraud detection component determines whether or not the article is the unsettled commodity based on a position before the movement of the article moved to the bag packing stand.

16. The self-service POS terminal according to claim 15, wherein
the fraud detection component identifies the position before the movement of the article based on captured image data of the operator.

17. The self-service POS terminal according to claim 14, further comprising:
a notification controller configured to notify fraud detection if the movement of the unsettled commodity to the bag packing stand is detected.

18. The self-service POS terminal according to claim 14, wherein
until the settlement is completed, the fraud detection component detects the movement of the unsettled commodity to the bag packing stand based on the weight change of the weight applied to the bag packing stand and commodity information of the registered commodity.

19. The self-service POS terminal according to claim 14, further comprising:
a scanner configured to read commodity information from code symbols.

20. The self-service POS terminal according to claim 14, wherein
the detection controller comprises a motion sensor.
